(19) United States
(12) Patent Application Publication
(10) Pub. No.: US 2023/0347628 A1
(43) Pub. Date: Nov. 2, 2023

(54) REINFORCED ROOF PANEL FOR MOBILE HOMES AND REFRIGERATED LORRIES

(71) Applicant: SIKA TECHNOLOGY AG, Baar (CH)

(72) Inventor: Frank EICHHORN, Calw (DE)

(73) Assignee: SIKA TECHNOLOGY AG, Baar (CH)

(21) Appl. No.: 17/914,229

(22) PCT Filed: Apr. 15, 2021
(86) PCT No.: PCT/EP2021/059824

§ 371 Date: Sep. 23, 2022

(30) Foreign Application Priority Data
Apr. 22, 2020 (EP) 20170852.6

(51) Int. Cl. B32B 21/08; B32B 21/04; B32B 21/10; B32B 7/12; B32B 27/06

(52) U.S. Cl. CPC B32B 21/08; B32B 21/047; B32B 21/10; B32B 7/12; B32B 27/065; B32B 2605/00; B32B 2250/03; B32B 2250/40; B32B 2260/023; B32B 2260/046; B32B 2262/106; B32B 2262/101; B32B 2307/304; B32B 2307/7376; B32B 2266/0278; B32B 2266/0235; B32B 2266/025

(57) ABSTRACT

A flat composite material based on a flat porous rigid material and one or more elongate elements of a fiber reinforced plastic material for stiffening the basis material, wherein the thickness of the elongate elements is smaller than that of the flat porous rigid material.

### TECHNICAL FIELD

The present invention relates to a flat composite material based on a flat porous rigid material and one or more elongate elements of a fiber reinforced plastic material for stiffening the basis material. The thickness of the elongate elements made of a fiber reinforced plastic material is smaller than that of the flat porous rigid material. The present invention further relates to sandwich panels containing such a composite material, to processes for producing such composite materials and sandwich panels and to the use of elongate elements made of fiber reinforced plastic materials for reinforcing corresponding sandwich panels.

### PRIOR ART

Sandwich panels for installation in roof or side applications for travel trailers or refrigerated trailers of trucks or transporters for example are normally not substantially stiffened. Corresponding sandwich panels generally comprise a core of an insulation material (for example a polyurethane foam) which is enclosed on both sides by a respective outerlayer. Such outerlayers may be produced, for example, from materials such as glass fiber reinforced plastics based on polyester but also from metals, such as aluminum, with polymer-based materials being preferred in vehicle applications due to their low weight, easier repairability and better corrosion resistance (for example to road salt).

Particularly due to the relatively large dimensions of the panels and the overall structure, roofs or side walls made entirely of plastics face the difficulty of adequate stiffening which is often determined only by the stiffness of the materials used for production of the sandwich panels. In extreme cases, such as those that occur in accidents, this may be insufficient, with the result that the structure fractures under heavy loads, thus potentially endangering vehicle passengers or other road users. This problem particularly affects regions where the panels are discontinuous, due to the presence of holes for windows for example.

Steel reinforcers, which are introduced into the panels, are installed in the panels to improve the stiffness of the overall structure. In some cases these steel reinforcers are tubes which are likewise filled with rigid foam in order thus to avoid cold bridges between the inner surface and the outer surface of the vehicle. However, in addition to unfavorable thermal conductivity properties, steel as a material has the disadvantage of a relatively high weight, which is disadvantageous in the context of constantly increasing demands with regard to the fuel consumption of vehicles.

Even if the stiffness required for safety reasons is afforded by the materials of the panels from which, for example, the roof structure is produced, roof structures produced from sandwich panels can suffer from the formation of puddles on the roof due to deflection of the panels. This problem can only be partially alleviated by stiffening steel tubes since such steel tubes likewise deflect under load and the use of a large number of steel tubes, which could prevent this effect, is impossible for weight reasons.

A further option for stiffening and insulation that has been suggested is wood, for example in the form of rods or panels, which can be integrated into the panel structure.

WO 2017/087623 A1 discloses a process for producing a rigid polymer composite material which comprises coating a film or textile layer with fibers or minerals and optionally with a binder and subsequent pressing with application of heat. A polymer is then extruded onto the stiffening element produced in this way. This method is relatively complex and performance thereof requires several laborious steps.

US 2013/122244 A1 discloses panels for aircraft interiors and production thereof, wherein these panels comprise a reinforcing core which may be made of foams or polymer rods for example. These panels are used predominantly for acoustic and thermal insulation in aircraft.

DE 36 38 797 A1 discloses an acoustic floor insulation panel made of foamed plastic for floating screeds or floating wood floor coverings, wherein the panel comprises especially arranged cavities. The disclosed panels exhibit a low stiffness as required for acoustic floor insulation in construction, as well as good insulation and fire retardant properties.

In view of the above there is a need for stiffening means for corresponding sandwich panels which, compared to metal-based reinforcers, exhibit reduced weight, are easy to install and can provide a comparable stiffening effect. Furthermore, the reinforcing meaning should ideally not form thermal bridges.

The present invention addresses this need.

### DESCRIPTION OF THE INVENTION

In a first aspect the present invention relates to a flat composite material comprising a flat porous rigid material as a basis and one or more elongate elements of a fiber reinforced plastic material. The elongate element made of reinforced material has a thickness smaller than that of the laminar porous rigid material.

In the context of the present invention “flat” is to be understood as meaning that the dimensions of material in at least one spatial direction (for example length or width) are markedly larger (i.e. by a factor of at least 5) than in the third spatial direction (for example thickness). It is preferable when at least one of the dimensions of the larger spatial directions are at least 10 times, in particular at least 50 times and more preferably at least 100 times, larger than the dimension of the third (smaller) spatial direction. The “flat” composite material may accordingly be in the form, for example, of a panel where the dimensions of the material in two spatial directions (for example length and width) are markedly larger than in the third spatial direction or in the form of an elongate support where the dimensions of the material in only one spatial direction are markedly larger than in the third spatial direction. In the case of a support the dimensions in both spatial directions of lesser extent may be identical or different.

The term “porous” refers to the fact that the material has pores that are filled with a gas, preferably air. The (dry) density of the porous material is generally less than 950 kg/m³, preferably less than 800 kg/m³ and more preferably less than 700 kg/m³. A density of at least 100 kg/m³, in particular at least 200 kg/m³ and more preferably at least 300 kg/m³ may be specified as a reasonable lower limit, for example to ensure an advantageous strength.

The material is “rigid”, i.e. inelastic, and a panel having a thickness of 1 cm and a length and width of 20 cm can therefore be deflected by not more than 2 cm and preferably not more than 1 cm when subjected to a force of 5 to 20 N.

The term “as a basis” is to be understood as meaning that the flat porous rigid material provides the substantial volume fraction of the flat composite material, i.e. especially a volume fraction of at least 80% by volume, preferably at least 90% by volume and more preferably at least 95%.

In the context of the invention described herein an “elongate element” is to be understood as meaning a material whose extent in one spatial direction is markedly (i.e. preferably at least 5 times) larger than its extent in the other two spatial directions. It is further preferable when the extent in the two smaller spatial directions differs by at least a factor of 2 and preferably at least a factor of 3, so that for example the elongate element is at least twice or at least three times as wide as it is thick. This shape realizes a maximum stiffening effect on the one hand and a minimum material weight on the other hand. Suitable shapes of elongate elements are for example strips or fins or a cylindrical or hollow-cylindrical shape. In the context of the present invention a strip shape is particularly preferred. In the case of a hollow-cylindrical shape, the “hollow cylinder” may also be filled with another material, for example wood.

The fiber reinforced plastic material, also known as FRP, is a composite material comprising a polymer matrix reinforced with fibers. The polymer matrix is usually based on epoxy, vinyl ester or a thermoplastic polyester resin, but can also be formed from a different polymer material. Fibers that may be present in the composite materials include glass fibers or carbon fibers but also fibers made of aramid or basalt, wherein glass and carbon fibers are preferred and carbon fibers are particularly preferred. Carbon fiber reinforced plastics are also known as CFK or CFRP. The fibers and in particular the carbon fibers may be present as individual fibers, fiber bundles, or as woven carbon fiber materials. The fiber reinforced plastic material may either itself be stiff and thus directly mediate a stiffening effect or may also be flexible, for example windable onto rollers, wherein in this case the stiffening effect is mediated by secure bonding to another material, such as in particular the flat rigid material.

A particularly suitable carbon fiber reinforced plastic material for use in the present invention has a fiber volume content of more than 50% and preferably in the range from 55% to 80%. Such a carbon fiber reinforced plastic material is available for example from Sika under the trade names Sika® Carbodur® S or Sika® Carbodur® M.

In one embodiment the elongate element(s) made of fiber reinforced plastic material is/are bonded to the flat porous rigid material forming the basis of the composite material using an adhesive.

Suitable adhesives are, in particular, polyurethane adhesives, in particular two-component polyurethane adhesives, epoxy adhesives, in particular toughened epoxy adhesives, adhesives based on silane-terminated polymers (STP), in particular 2K STP adhesives, and also STP-epoxy hybrid adhesives. An example of a preferred suitable adhesive type is an adhesive based on polyurethane and in particular a 2K polyurethane.

2K polyurethane adhesives that are particularly suitable for the present invention are disclosed for example in WO 2020/016003 A1 and WO 2019/002538 A1. A 2K epoxy adhesive that is particularly suitable for the present invention is disclosed for example in WO 2020/016372 A1.

Adhesives that are particularly suitable in this context preferably exhibit one or more properties selected from a tensile shear strength in the range from 5 to 30 N/mm², preferably 10 to 20 N/mm², a tensile strength in the range from 5 to 30 N/mm², preferably 10 to 20 N/mm², an elongation at break in the range from 60% to 200% and in particular 80% to 150% and a modulus of elasticity in the range from 200 to 600 N/mm² and in particular 250 to 500 N/mm². An example of particularly suitable adhesive is for example obtainable from Sika under the trade name SikaForce®-840. Such adhesives are advantageous because they ensure good adhesion between the fiber reinforced plastic material and the flat porous rigid material while avoiding stresses between the two materials which can occur in an injection molding process for example.

In another embodiment the flat composite material may be produced by offering one or more elongate elements made of fiber reinforced plastic material into a cavity, into which a material that forms a rigid foam around the fiber-reinforced plastic material is then introduced by injection molding. The injected material/injection molding material is then cured to afford a rigid foam. In this case the bonding of the rigid foam material to the fiber-reinforced plastic material occurs as a result of the curing.

In a further embodiment one or more elongate elements of fiber reinforced plastic material are introduced into the flat porous rigid material by for example initially drilling a corresponding hole in the porous rigid material, into which the elongate element may be introduced. For such an application the exclusive use of a flexible fiber reinforced plastic material is less suitable, since the required join with the flat porous rigid material can be realized only with difficulty here. However, it is also possible for example to initially join an elastic fiber reinforced plastic material with a stiff material, for example a wood element, in order thus to form a stiffening element.

It is finally also possible to inject an uncured fiber reinforced plastic material into elongate recesses of a flat porous rigid material and effect curing therein.

The flat porous rigid material may be any material employed today to provide porous basis materials of sandwich panels or non-metallic stiffening supports of such panels. It is particularly preferable when the flat porous rigid material comprises or is based on a plastic foam, in particular a polyurethane, polyvinyl chloride or polyethylene foam, or wood. The flat porous rigid material very particularly preferably consists of one or more of these materials.

The elongate elements and in particular the strips of the fiber reinforced and preferably of the carbon fiber reinforced plastic material that are incorporated into the flat composite material advantageously have a width in the range from about 20 to 100 mm, preferably from about 15 to 70 mm and yet more preferably from about 30 to 50 mm. Alternatively or in addition the elongate elements or strips of the fiber reinforced plastic material have a thickness in the range from 0.8 to 3 mm and more preferably 1 to 1.5 mm.

The spatial and in particular two-dimensional extent of the elongate elements of the fiber reinforced plastic material is generally smaller than that of the flat composite material. When the flat composite material is a two-dimensional composite material such as a panel it is preferable when the two-dimensional extent of the elongate elements of the fiber reinforced plastic material is in the range from 1% to 50%, preferably 2% to 30% and more preferably 5% to 15% of the two-dimensional extent of the flat composite material. If the flat composite material is markedly larger in only one dimension than in the other two dimensions it is preferable when the two-dimensional extent of the longitudinal elements of the fiber reinforced plastic material is in the range from 20% to 90%, preferably 40% to 85% and yet more preferably 50% to 80% of the two-dimensional extent of the flat composite material.

The flat composite material according to the invention may advantageously be further formed with one or more outerlayers arranged on the top surface and/or bottom surface of the flat composite material. This outerlayer or the outerlayers are preferably compact, i.e. nonporous. A particularly suitable material for such outerlayers may be a fiber reinforced plastic, for example based on polyesters or a metal such as especially aluminum.

If the flat composite material is modified with one or more outerlayers it is also possible for the elongate element(s) made of fiber reinforced plastic material to be joined to the outerlayer, wherein the join may advantageously be realized with appropriate adhesive.

If the elongate element made of fiber reinforced plastic material is attached by its top surface or bottom surface to the flat porous rigid material it may be advantageous when elongate elements and in particular strips of material are attached both on the top surface and on the bottom surface of the material. In the case of such a configuration the flat composite material is stiffened against forces acting on the flat composite material from the top surface and the bottom surface. However, depending on the application it may also be sufficient when the flat composite material is only stiffened against forces acting on the composite material from one side, for example in the case of rainwater collecting on a roof. In one embodiment elongate elements of the fiber reinforced plastic material may accordingly only be attached on one side of the composite material, preferably on the bottom surface thereof.

It is moreover also possible for two or more elongate elements to be attached to the flat porous rigid material in one direction or for elongate elements to cross over one another, for example at an angle of about 60° or about 90°, or for example to be attached to the material in a checkerboard fashion, in order to achieve stiffening not only in one, but rather in two or more, spatial directions.

In a particularly preferred embodiment the flat composite material is in the form of a support having a length that is large compared to its thickness and width (preferably more than 8 times, more preferably more than 15 times and yet more preferably more than 25 times the longer of thickness and width). Examples of suitable dimensions for thickness and width may be a range from 15 to 60 mm and in particular 20 to 45 mm. The length of the support is preferably at least 500 mm and more preferably at least 1000 mm. The length of the support is not limited to a relevant degree but for most applications a length of not more than 3000 mm is sufficient.

A preferred support contains two elongate elements arranged spaced apart from one another in the support, i.e. for example on the top surface and the bottom surface or in a support with a distance to one side which is greater than the distance to the respective other side.

In a further aspect the present invention relates to a sandwich panel which comprises an inner core layer and a top outerlayer and a bottom outerlayer which form the respective outer surfaces of the sandwich panel, wherein the core layer comprises one or more elements of the aboved-described flat composite material. The composite material may be for example in the form of a panel forming the inner core layer or the composite material may be in the form of one or more supports which are arranged between the outerlayers and do not completely occupy the inner core layer.

Having regard to materials suitable for such sandwich panels and dimensions or arrangements of the individual elements of the sandwich panel, reference may be made to the preceding elucidations in connection with the flat composite material according to the invention.

A sandwich panel preferred in the context of the present invention contains one or more supports formed from the flat composite material according to the invention in the core layer. It is preferable when the space of the core layer not occupied by the composite material is filled with an insulation material, such as glass wool or a polymer foam. It is further preferable when the elongate elements in such sandwich panels are arranged parallel to the outerlayers, wherein “parallel” here refers to the surface of the elongate elements having the greatest extent.

It is very particularly preferred if the sandwich panel is a roof or a side wall of a vehicle, preferably of a travel trailer, motor home or refrigerated trailer. A further aspect of the present invention relates to a process for producing a flat composite material or a sandwich panel, in each case as described hereinabove, wherein the process comprises a step of contacting a flat porous rigid material with one or more elongate elements of a fiber-reinforced plastic material, wherein the elongate element(s) have a thickness which is smaller than that of the flat porous rigid material. As specified hereinabove the contacting may be realized in particular by offering the elongate elements of the fiber reinforced and preferably of the carbon fiber reinforced plastic material and injecting a material that cures to afford a rigid foam, by attaching the elongate elements of the fiber reinforced plastic material to a rigid foam or another flat porous rigid material, in particular using adhesive, by introducing material that cures to afford a fiber reinforced plastic material into recesses in a flat porous rigid material or by introducing an elongate element made of cured fiber reinforced plastic material into recesses of a flat porous rigid material.

Finally, yet a further aspect of the present invention relates to the use of elongate elements made of fiber reinforced plastic material for reinforcing a sandwich panel having a core made of a flat porous rigid material and upper and lower outerlayers which form the respective outer surfaces of the sandwich panel.

The invention will now be more particularly illustrated by examples which, however, should not to be understood as in any way limiting to the scope of protection of the present application.

### EXAMPLE

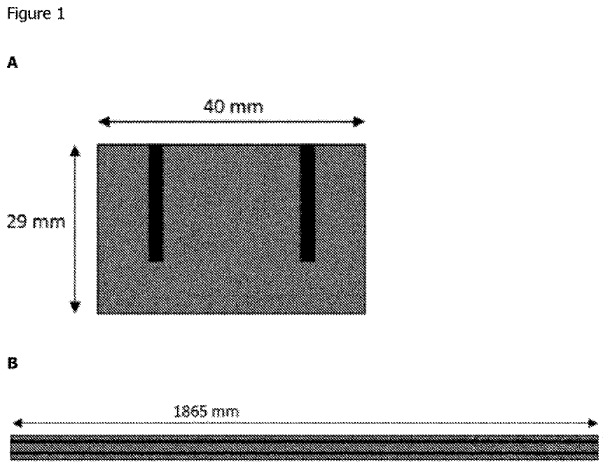

A polyurethane support having the dimensions: thickness=29 mm×width=40 mm×length=1865 mm was produced. Two Carbodur® tapes having a width of 20 mm are embedded in this support such that the tapes are positioned at the surface of the support at one end (see FIG. 1).

1. A flat composite material comprising a flat porous rigid material as a basis and one or more elongate elements of a fiber reinforced plastic material having a thickness smaller than that of laminar porous rigid material.

2. The flat composite material as claimed in claim 1, wherein the fiber reinforced plastic material contains glass or carbon fibers.

3. The flat composite material as claimed in claim 1, wherein the elongate element(s) made of fiber reinforced plastic material is/are bonded to the flat porous rigid material using an adhesive.

4. The flat composite material as claimed in claim 1 obtainable by injection molding a material that forms a rigid foam around the elongate elements made of fiber-reinforced plastic material and subsequently curing the injection molding material to form a rigid foam.

5. The flat composite material as claimed in claim 1, wherein the elongate element(s) made of fiber reinforced plastic material is/are inserted into the flat porous rigid material.

6. The flat composite material as claimed in claim 1, wherein the flat porous rigid material is based on a polyurethane, polyvinyl chloride or polyethylene foam.

7. The flat composite material as claimed in claim 1, wherein the flat porous rigid material is wood.

8. The flat composite material as claimed in claim 1, further comprising one or more outerlayers arranged on the top surface and/or bottom surface of the flat porous rigid material.

9. The flat composite material as claimed in claim 8, wherein the outerlayer(s) is/are made of a fiber reinforced plastic.

10. The flat composite material as claimed in claim 8, wherein the elongate element(s) made of fiber reinforced plastic material is/are joined to the outerlayer.

11. The flat composite material as claimed in claim 1, wherein the elongate elements of the fiber reinforced plastic material have a width in the range from about 20 to 100 mm, and/or a thickness in the range from 0.8 to 3 mm.

12. The flat composite material as claimed in claim 1, wherein the two-dimensional extent of the elongate elements of the fiber reinforced plastic materials is in the range from 1% to 50% of the two-dimensional extent of the flat composite material when this is in the form of a two-dimensional composite material and in the range from 20% to 90% of the two-dimensional extent of the flat composite material when only one dimension of the flat composite material is markedly larger than the two other dimensions.

13. A sandwich panel comprising an inner core layer and a top outerlayer and a bottom outerlayer, wherein the core layer contains one or more flat composite materials as claimed in claim 1.

14. The sandwich panel as claimed in claim 13, wherein the core layer contains one or more supports formed from the flat composite material according to the invention and wherein a region of the core layer not occupied by the support(s) is filled with an insulation material.

15. The sandwich panel as claimed in claim 13, wherein the sandwich panel is a roof or a side wall of a vehicle.

16. A process for producing a flat composite material comprising:
preparing a flat porous rigid material as a basis and one or more elongate elements of a fiber reinforced plastic material having a thickness smaller than that of laminar porous rigid material, or
preparing a sandwich panel as claimed in claim 13, and
contacting a flat porous rigid material with one or more elongate elements of a fiber-reinforced plastic material, wherein the strip(s) have a thickness which is smaller than that of the flat porous rigid material.

17. A method of producing a flat composite material comprising:
applying elongate elements made of fiber reinforced plastic material for reinforcing a sandwich panel having a core made of a flat porous rigid material and upper and lower outerlayers which form the respective outer surfaces of the sandwich panel.
